(19) United States
(12) Patent Application Publication
(10) Pub. No.: US 2018/0034652 A1
(43) Pub. Date: Feb. 1, 2018

(54) TERMINAL AND METHOD OF CONTROLLING SAME

(71) Applicant: SHARP KABUSHIKI KAISHA, Sakai City, Osaka (JP)

(72) Inventors: AKIHIRO OKAZAKI, Sakai City (JP); HISASHI IDE, Sakai City (JP); MASAHIRO UEDA, Sakai City (JP)

(21) Appl. No.: 15/555,457

(22) PCT Filed: Feb. 22, 2016
(86) PCT No.: PCT/JP2016/055088

§ 371 Date: Sep. 1, 2017

(30) Foreign Application Priority Data
Mar. 31, 2015 (JP) 2015-074170
Aug. 27, 2015 (JP) 2015-168122

(51) Int. Cl. H04L 12/18; H04L 12/28

(52) U.S. Cl. CPC H04L 12/189; H04L 12/2816; H04W 84/12

(57) ABSTRACT

In a case of transmitting a request to home information appliances (5), a mobile terminal (4) transmits a message for multicast to a wireless router (3). In a case where the mobile terminal (4) receives no response to the message for multicast from any of the home information appliances (5) within a given period of time from the transmission of the message for multicast, the mobile terminal (4) transmits a message for broadcast to the wireless router (3).

### TECHNICAL FIELD

The present invention relates to (i) a terminal which communicates with one or more terminals via a communication network and (ii) a method of controlling the terminal.

### BACKGROUND ART

Communications on a computer network can be generally classified into three types, i.e., a unicast, a multicast, and a broadcast, according to the number of communication destinations. The unicast refers to a one-to-one communication in which a message is transmitted to a single destination. The multicast refers to a one-to-multiple communication in which a single message is simultaneously transmitted to a plurality of specific destinations. The broadcast refers to a one-to-indefinite many communication in which a single message is simultaneously transmitted to all destinations.

The unicast is the most commonly-used communication. In the case of establishing the one-to-multiple communication, the multicast allows a reduction in load on a communication network, as compared with the unicast. The broadcast is an important communication that is established so as to realize the unicast and the multicast. Patent Literature 1 discloses a method of offering, via a cellular network, a multicast service and/or a broadcast service to a user's terminal device.

### CITATION LIST

### Patent Literature

Patent Literature 1

Japanese Patent Application Publication Tokuhyo No. 2005-507225 (Publication date: Mar. 10, 2005)

### SUMMARY OF INVENTION

### Technical Problem

In the case of the multicast, a router can receive a message from a source, replicates the message, and then transmits the message thus replicated to each of destinations. However, the router can sometimes not transmit the message to each of the destinations due to, for example, the following causes: (i) the router is incompatible with the multicast, (ii) the router is set so as not to establish any multicast, or (iii) the router cannot carry out the multicast due to, for example, an increase in traffic volume. The causes (i) through (iii) are therefore difficult to identify.

In view of the circumstances, the router can alternatively transmit the message by broadcast. Such an alternative increases the likelihood that the message is transmitted to each of the destinations, as compared with a configuration in which the message is multicasted.

Note, however, that since the broadcast is a one-to-indefinite many communication, an increase is caused in load on a communication network, as compared with the multicast which is a one-to-specific multiple communication. Note that, even in the case of establishing the broadcast, the router can sometimes not transmit the message to each of the destinations.

The present invention has been made in view of the above problem, and an object of the present invention is to provide, for example, a terminal which can securely transmit a message to specific destinations while restraining an increase in load on a communication network.

### Solution to Problem

In order to attain the above object, a terminal in accordance with an embodiment of the present invention is a terminal which communicates with one or more terminals via a communication network, the terminal including: a control section configured to control a communication between the terminal and the one or more terminals, in a case where the control section transmits a message to a group of the one or more terminals, the control section controlling the communication so that a message for multicast, in which the group of one or more terminals are designated as respective destinations, is transmitted to the communication network, in a case where the control section receives no response to the message for multicast from any of the group of the one or more terminals within a given period of time from transmission of the message for multicast, the control section controlling the communication so that a message for broadcast, in which all of the one or more terminals are designated as the respective destinations, is transmitted to the communication network.

In order to attain the above object, a terminal in accordance with another embodiment of the present invention is a terminal which communicates with one or more terminals via a communication network, the terminal including: a control section configured to control a communication between the terminal and the one or more terminals, in a case where the control section transmits a message to a group of the one or more terminals, the control section controlling the communication so that (i) a message for multicast, in which the group of the one or more terminals are designated as respective destinations, and (ii) a message for broadcast, in which all of the one or more terminals are designated as respective destinations, are transmitted to the communication network.

### Advantageous Effects of Invention

An embodiment of the present invention brings about an effect of securely transmitting a message to specific destinations while restraining an increase in load on a communication network.

### BRIEF DESCRIPTION OF DRAWINGS

FIG. 1 is a block diagram schematically illustrating a configuration of a wireless LAN system in accordance with an embodiment of the present invention.

FIG. 2 is a block diagram schematically illustrating a configuration of a home information appliance included in the wireless LAN system.

FIG. 3 is a block diagram schematically illustrating a configuration of a mobile terminal included in the wireless LAN system.

FIG. 4 is a flowchart illustrating how the mobile terminal collects status information.

FIG. 5 is a block diagram schematically illustrating a configuration of a mobile terminal included in a wireless LAN system in accordance with another embodiment of the present invention.

FIG. 6 is a flowchart illustrating how the mobile terminal collects status information.

FIG. 7 is a block diagram schematically illustrating a configuration of a mobile terminal included in a wireless LAN system in accordance with another embodiment of the present invention.

FIG. 8 is a flowchart illustrating how the mobile terminal collects status information.

FIG. 9 is a block diagram schematically illustrating a configuration of a mobile terminal included in a wireless LAN system in accordance with another embodiment of the present invention.

### DESCRIPTION OF EMBODIMENTS

The following description will discuss, in detail, embodiments of the present invention. Note that, for convenience, members having functions identical to those of respective members described in the embodiments are given respective identical reference numerals, and descriptions of such members are omitted as appropriate.

### Embodiments 1 Through 3 and 7

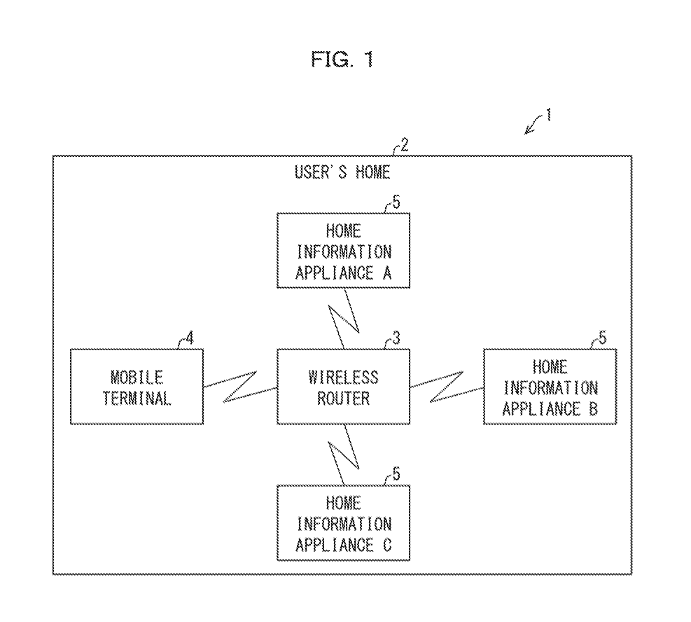

First, each of Embodiments 1 through 3 and 7 of the present invention will be discussed below with reference to FIGS. 1 through 4.

(Configuration of Indoor LAN)

FIG. 1 is a block diagram schematically illustrating a configuration of a wireless local area network (LAN) system 1 in accordance with each of Embodiments 1 through 3 and 7. As illustrated in FIG. 1, the wireless LAN system (communication network) 1 includes a plurality of information terminals (e.g., a mobile terminal, a personal computer (PC), and a home information appliance) which are located and connected in a user's home 2 so as to communicate with each other via a wireless router 3. In such an example illustrated in FIG. 1, a single mobile terminal (terminal) 4 and three home information appliances (one or more terminals) 5 are connected so as to communicate with each other via the wireless router (communication network) 3. Note, however, that the number of and the types of the mobile terminal 4 and the home information appliances 5 are not limited as such.

The wireless router 3 can be connected to a wide area network (e.g., the internet) via, for example, a telephone network, a mobile communication network, a cable television (CATV) communication network, or a satellite communication network.

According to each of Embodiments 1 and 7, in a case of collecting pieces of status information from the respective home information appliances 5, the mobile terminal 4 first transmits, to the wireless router 3, a request (message) which is for the pieces of status information and which is for multicast in which the home information appliances 5 (i.e., a group of one or more terminals) are designated as respective destinations. When possible, the wireless router 3 multicasts the request to each of the home information appliances 5. This allows a lighter load on the wireless LAN system 1, as compared with a case where the wireless router 3 broadcasts the request to all information terminals that are connected so as to communicate with the wireless router 3.

Subsequently, upon receipt of a response to the request, i.e., upon receipt of the pieces of status information from the respective home information appliances 5, the wireless router 3 transmits the pieces of status information thus received to the mobile terminal 4. The mobile terminal 4 can thus collect the pieces of status information from the respective home information appliances 5.

Note that the wireless router 3 can sometimes not carry out any multicast. In such a case, for example, (i) the wireless router 3 essentially does not have a function of multicast, (ii) the wireless router 3 is set so that the multicast is prohibited, and/or (iii) the wireless router 3 is configured so that the multicast is disabled by a specific setting. In a case where the wireless router 3 cannot carry out any multicast, the mobile terminal 4 cannot collect any status information from the home information appliances 5.

As such, each of Embodiments 1 and 7 is configured so that, in a case where the mobile terminal 4 does not receive status information from any of the home information appliances 5 within a given period of time (e.g., 10 seconds) from the transmission of the request for multicast, the mobile terminal 4 transmits, to the wireless router 3, a request for broadcast in which all information terminals, which are connected so as to communicate with the wireless router 3, are designated as respective destinations. This increases the likelihood that such a request is transmitted to each of the home information appliances 5, though the load on the wireless LAN system 1 increases as compared with a case where the request for multicast is transmitted to the wireless router 3.

It is therefore possible to securely transmit the request for status information to each of the home information appliances 5, while restraining an increase in load on the wireless LAN system 1.

(Home Information Appliance)

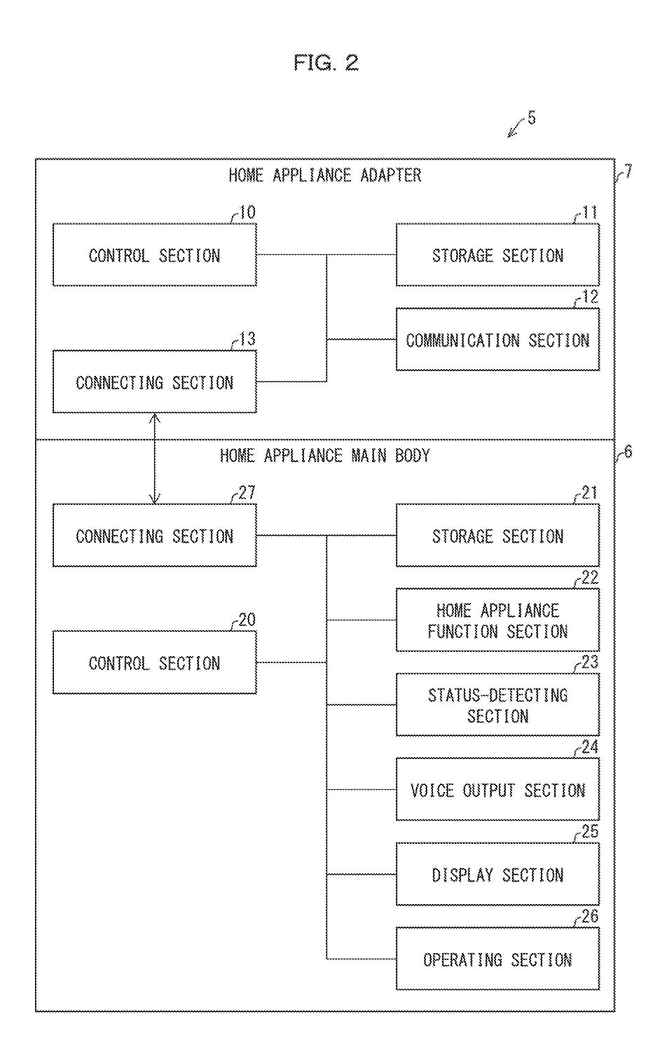

FIG. 2 is a block diagram schematically illustrating a configuration of a home information appliance 5 included in the wireless LAN system 1. As illustrated in FIG. 2, the home information appliance 5 includes (i) a home appliance main body 6 and (ii) a home appliance adapter 7 which is connected to the home appliance main body 6. The home appliance adapter 7 causes the home appliance main body 6 to be connected to the wireless router 3, and allows the home appliance main body 6 to be controlled via the wireless router 3. The home appliance adapter 7 is thus a device which causes the home appliance main body 6 to serve as a so-called home information appliance. The home appliance adapter 7 includes a control section 10, a storage section 11, a communication section 12, and a connecting section 13 (see FIG. 2).

The control section 10 is a block for comprehensively controlling operations of respective sections included in the home appliance adapter 7. The storage section 11 is a block for storing various kinds of information used in the home appliance adapter 7.

The communication section 12 is a block for wirelessly communicating with the wireless router 3. The communication section 12 thus allows the home appliance adapter 7 to mutually communicate, via the wireless router 3, with the mobile terminal 4 and other home information appliances 5.

The connecting section 13 of the home appliance adapter 7 is a block for mutually communicating with a connecting section 27 of the home appliance main body 6. The connecting section 13 and the connecting section 27 of the home appliance main body 6 can be connected via, for example, a universal serial bus (USB) connector.

Examples of the home appliance main body 6 encompass an air-conditioning apparatus (i.e., an air conditioner), an air purifier, a refrigerator, a washing machine, a cooking device, an illuminating device, a water heater, a photographing device, an audio-visual (AV) device, and a home robot (e.g., a cleaning robot, a housework-assisting robot, or a zoomorphic robot). As illustrated in FIG. 2, the home appliance main body 6 includes a control section 20, a storage section 21, a home appliance function section 22, a status-detecting section 23, a voice output section 24, a display section 25, an operating section 26, and the connecting section 27. Upon receipt of an operation signal from the mobile terminal 4, the home appliance main body 6 is controlled by the control section 20 to conduct an operation in accordance with the operation signal thus received.

The control section 20 is a block for controlling operations of respective sections included in the home appliance main body 6. The control section 20 is constituted by, for example, a computer device which includes an arithmetic processing section such as a central processing unit (CPU) or a dedicated processor. The control section 20 comprehensively controls operations of respective sections included in the home appliance main body 6, by (i) reading out, from the storage section 21, a program for implementing various kinds of control in the home appliance main body 6 and (ii) executing the program thus read out.

The storage section 21 includes a random access memory (RAM), a read only memory (ROM), and a hard disk drive (HDD). The storage section 21 is a block for storing various kinds of data used in the home appliance main body 6. The storage section 21 stores therein, in advance (e.g., before shipping), voice data which is to be outputted from the home appliance main body 6.

The home appliance function section 22 functions as the home appliance main body 6. For example, in a case where the home appliance main body 6 is an air conditioner, the home appliance function section 22 has a function of air-conditioning. In a case where the home appliance main body 6 is a refrigerator, the home appliance function section 22 has a function of cooling. The home appliance function section 22 performs a function of the home appliance in accordance with an instruction from the control section 20.

The status-detecting section 23 is a block for (i) detecting a status of the home appliance main body 6 and (ii) creating status information indicative of the status of the home appliance main body 6 thus detected. Examples of the status information include information indicative of a setting condition of the home appliance main body 6, information indicative of an operating condition of the home appliance main body 6, and environmental information related to status where the home appliance main body 6 is located, i.e., environmental information related to surrounding environment of the home appliance main body 6. Examples of the environmental information include a temperature and humidity inside and outside the user's home 2. Note that these are illustrative only.

The voice output section 24 is a voice output device such as a speaker. The control section 20 controls the voice output section 24 to output a voice based on voice data stored in the storage section 21.

The display section 25 displays, on a display screen, a display content based on display data received from the control section 20. Specifically, the display section 25 includes (i) a display element such as a liquid crystal display (LCD), an electroluminescence (EL) display, or an electronic paper and (ii) a driver circuit for driving the display element based on the display data received by the display section 25.

The operating section 26 (i) accepts a user's operation entered via an input device, such as a button switch which is provided on a surface of the home appliance main body 6, (ii) creates operation data based on the user's operation thus accepted, and (iii) transmits the operation thus created to the control section 20. Examples of the input device, other that the button switch, include a touch panel and a remote controller. Note that the home appliance main body 6 can sometimes not include the voice output section 24, the display section 25, and the operating section 26, depending on a type, a manufacturer, a model number, and the like of the home appliance main body 6.

The connecting section 27 is a block for mutually communicating with the connecting section 13 of the home appliance adapter 7.

As described above, each of Embodiments 1 and 7 is configured such that the home appliance adapter 7, which allows remote operation of the home appliance main body 6, is externally provided. Since the external provision of a communication function part which allows for remote operation is optional, it is possible to reduce production cost of the home appliance main body 6. Alternatively, the communication function component can be configured to be incorporated, in advance, in the home appliance main body 6, i.e., the home appliance adapter 7 and the home appliance main body 6 can be configured to be integrally provided.

(Mobile Terminal)

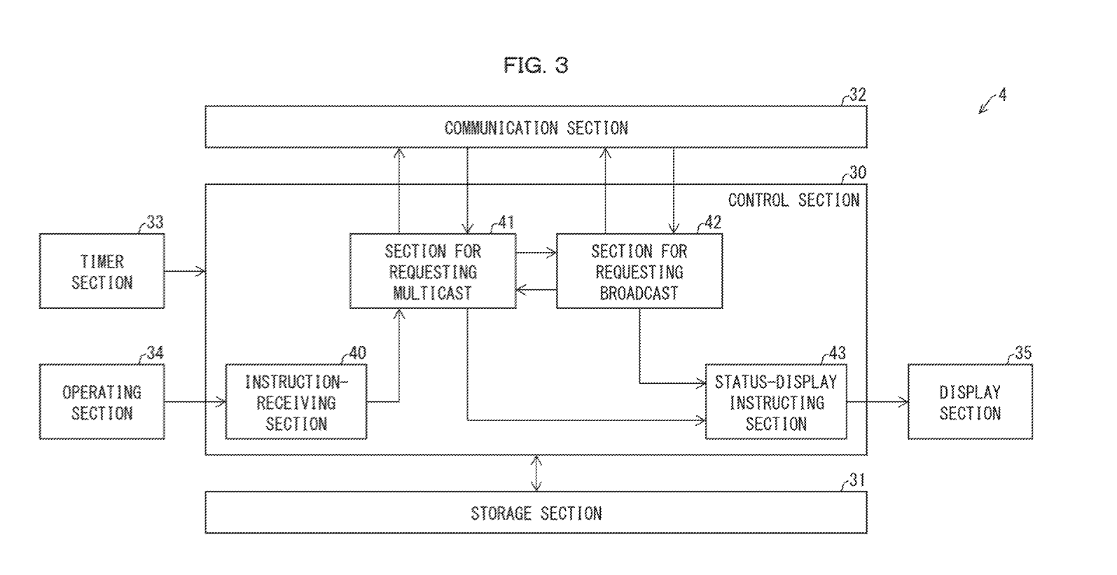

FIG. 3 is a block diagram schematically illustrating a configuration of the mobile terminal 4 included in the wireless LAN system 1. As illustrated in FIG. 3, the mobile terminal 4 includes a control section 30, a storage section 31, a communication section 32, a timer section 33, an operating section 34, and a display section 35. Note that the control section 30, the storage section 31, the operating section 34, and the display section 35 of the mobile terminal 4 are similar in hardware configuration to the control section 20, the storage section 21, the operating section 26, and the display section 25 of the home appliance main body 6, respectively, and descriptions thereof are therefore omitted. Note also that the communication section 32 of the mobile terminal 4 is similar in hardware configuration to the communication section 12 of the home appliance adapter 7, and descriptions thereof are therefore omitted.

The timer section 33 measures a period of time, and transmits, to the control section 30, information indicative of the period of time thus measured.

(Details of Mobile Terminal)

Next, the control section 30 of the mobile terminal 4 will be discussed in detail below. As illustrated in FIG. 3, the control section 30 includes an instruction-receiving section 40, a section 41 for requesting multicast, a section 42 for requesting broadcast, and a status-display instructing section 43.

The instruction-receiving section 40 receives, from the user via the operating section 34, an instruction to collect pieces of status information of the respective home information appliances 5. The instruction-receiving section 40 transmits, to the section 41, the instruction thus received.

The section 41 for requesting multicast creates a request for multicast in accordance with the instruction received from the instruction-receiving section 40, and transmits such a request to the wireless router 3 via the communication section 32. The request for multicast can be realized by (i) designating addresses (multicast addresses) for multicast as addresses of respective destinations of the request for multicast and (ii) incorporating the addresses for multicast in the request for multicast. Upon receipt of a response to the request for multicast from the wireless router 3 via the communication section 32, the section 41 for requesting multicast transmits the response thus received to the status-display instructing section 43.

According to Embodiment 2, in a case where the section 41 for requesting multicast receives, via the wireless router 3, no response to the request for multicast within a given period of time from the transmission of the request for multicast, the section 41 instructs the section 42 for requesting broadcast to make a request for broadcast.

Note here that even the wireless router 3, which is compliant with the multicast, can sometimes not temporarily carry out any multicast due to various causes such as an increase in communications traffic, limits of processing capacity, and/or a delay in operation. It is, however, highly likely that the multicast is carried out after a while.

In view of the circumstances, according to Embodiment 2, in a case where the section 41 for requesting multicast receives, via the wireless router 3, no response to the request for multicast within a given period of time from the transmission of the request for multicast, the section 41 retransmits the request for multicast to the wireless router 3. In a case where the section 41 retransmits a request for multicast to the wireless router 3 a given number of times (e.g., three times) but receives no response to the request, it instructs the section 42 for requesting broadcast to make a request for broadcast. This makes it possible to more securely transmit the request for pieces of status information to the respective home information appliances 5, while restraining an increase in load on the wireless LAN system 1.

The section 42 for requesting broadcast creates a request for broadcast based on the instruction from the section 41 for requesting multicast, and transmits the request for broadcast thus created to the wireless router 3 via the communication section 32. The request for broadcast can be realized by (i) designating addresses (broadcast addresses) for broadcast as addresses of respective destinations of the request for broadcast and (ii) incorporating the addresses for broadcast in the request for broadcast. Upon receipt of a response to the request for broadcast from the wireless router 3 via the communication section 32, the section 42 for requesting broadcast transmits the response thus received to the status-display instructing section 43.

Note here that even the wireless router 3, which is compliant with the broadcast, can sometimes not temporarily carry out any broadcast due to the above-described causes. It is, however, highly likely that the broadcast is carried out after a while.

In view of the circumstances, according to Embodiment 3, in a case where the section 42 for requesting broadcast receives no response to the request for broadcast within a given period of time (e.g., 10 seconds) from the transmission of the request for broadcast, the section 42 instructs the section 41 for requesting multicast to make a request for multicast again. This makes it possible to more securely transmit the request for pieces of status information to the respective home information appliances 5, while restraining an increase in load on the wireless LAN system 1.

Upon receipt of a response from the section 41 for requesting multicast or the section 42 for requesting broadcast, i.e., upon receipt of pieces of status information from the respective home information appliances 5, the status-display instructing section 43 instructs the display section 35 to display the pieces of status information thus received.

(Examples of Status Information)

In a case where, for example, a user wishes to check current operating conditions of the respective home information appliances 5 located in the user's home 2, the user instructs, via the operating section 34, the mobile terminal 4 to display the current status conditions of the respective home information appliances 5. The mobile terminal 4, in turn, transmits a request for multicast or a request for broadcast, each of which is a request (command) for pieces of status information indicative of respective operating conditions, to the respective home information appliances 5 via the wireless router 3, and receives responses to the requests from the respective home information appliances 5 via the wireless router 3. The mobile terminal 4, in turn, displays the responses thus received, i.e., the pieces of status information indicative of operating conditions of the respective home information appliances 5.

In a case where the home information appliance 5 is an air conditioner, examples of the status information of the home information appliance 5 include (i) information indicative of whether the air conditioner is in an operating state or a suspended state, (ii) information indicative of an operating mode (e.g., a cooling mode, a heating mode, and a dehumidifying mode) of the air conditioner, (iii) information indicative of a preset temperature of the air conditioner, and (iv) information indicative of a current room temperature. In a case where the home information appliance 5 is an air purifier, examples of status information of the home information appliance 5 include (i) information indicative of whether the air purifier is in an operating state or a suspended state, (ii) information indicative of an operating mode (e.g., a slow mode, a medium-speed mode, and a fast mode) of the air purifier, (iii) information indicative of current air pollution (e.g., a measurement value of, for example, a gas sensor or a dust sensor), and (iv) information indicative of a current room humidity.

(Process of Collecting Status Information)

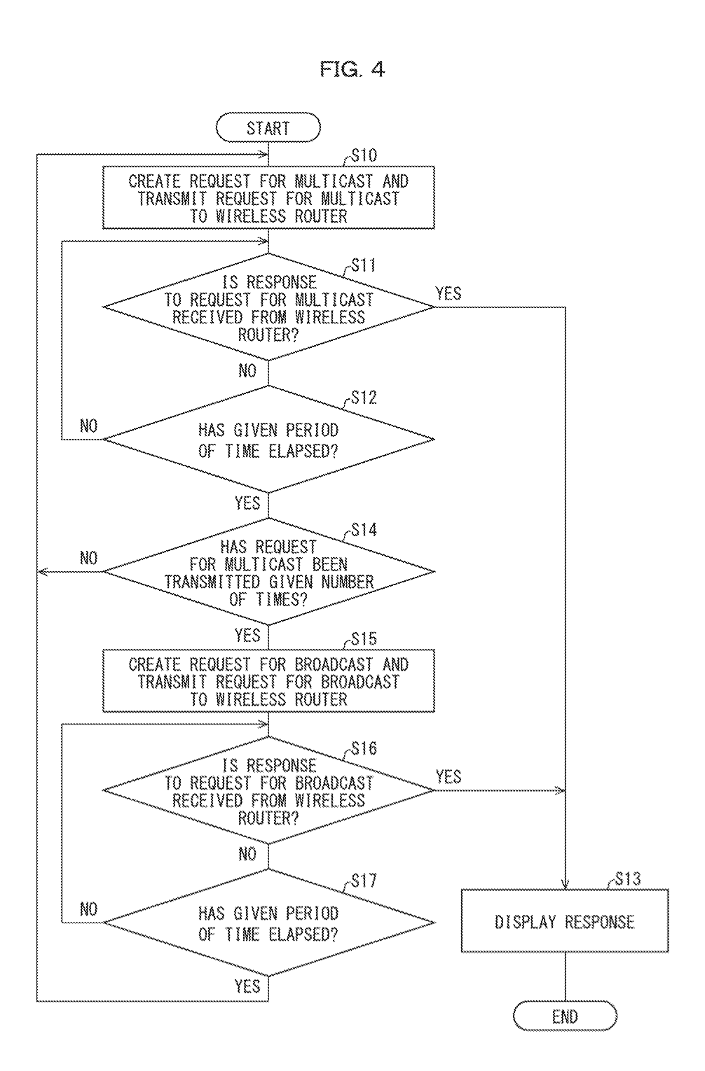

FIG. 4 is a flowchart illustrating how the mobile terminal 4 collects status information. In a case where a user instructs, via the operating section 34, the mobile terminal 4 to collect pieces of status information of the respective home information appliances 5, the section 41 for requesting multicast creates a request for multicast in accordance with the instruction, and transmits the request for multicast thus created to the wireless router 3 via the communication section 32 (S10) (see FIG. 4).

In a case where the section 41 for requesting multicast receives, via the wireless router 3, responses to the request for multicast within a given period of time from the transmission of the request for multicast (YES in S11), the status-display instructing section 43 causes the display section 35 to display the response, i.e., pieces of status information of the respective home information appliances 5 (S13), and then ends the process of collecting the pieces of status information.

In contrast, in a case where the section 41 for requesting multicast receives, via the wireless router 3, no response to the request for multicast within a given period of time from the transmission of the request for multicast (YES in S12), the step S10 is again proceeded with. In a case where the section 41 for requesting multicast repeats the steps S10 through S12 a given number of times (YES in S14), the section 42 for requesting broadcast creates a request for broadcast, and transmits the request for broadcast thus created to the wireless router 3 via the communication section 32 (S15).

In a case where the section 42 for requesting broadcast receives, via the wireless router 3, a response to the request for broadcast within a given period of time from the transmission of the request for broadcast (YES in S16), the step S13 is proceeded with, and the process of collecting the pieces of status information is then ended.

In contrast, in a case where the section 42 for requesting broadcast receives, via the wireless router 3, no response to the request for broadcast within the given period of time from the transmission of the request for broadcast (YES in S17), the step S10 is proceeded with so that the above steps will be repeated.

(Supplemental Notes)

Note that the step S14 can be omitted. In a case where the section 42 for requesting broadcast receives, via the wireless router 3, no response to the request for broadcast within the given period of time from the transmission of the request for broadcast (YES in S17), the status-display instructing section 43 can alternatively instruct the display section 35 to display an error message, instead of returning to the step S10.

### Embodiment 41

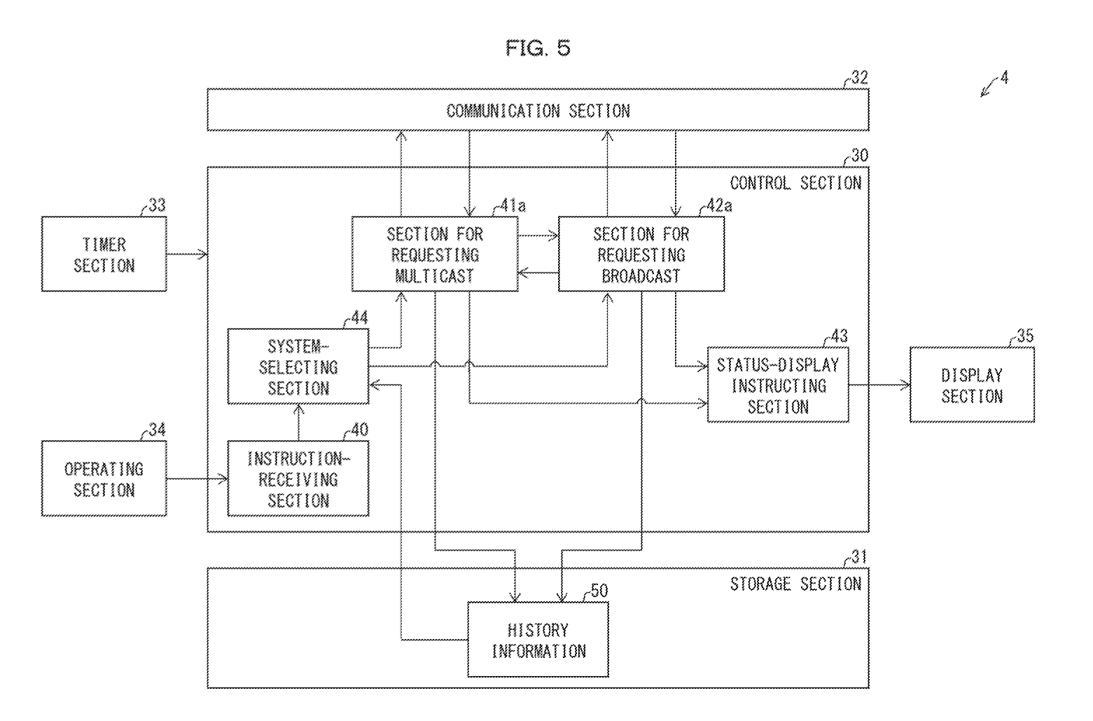

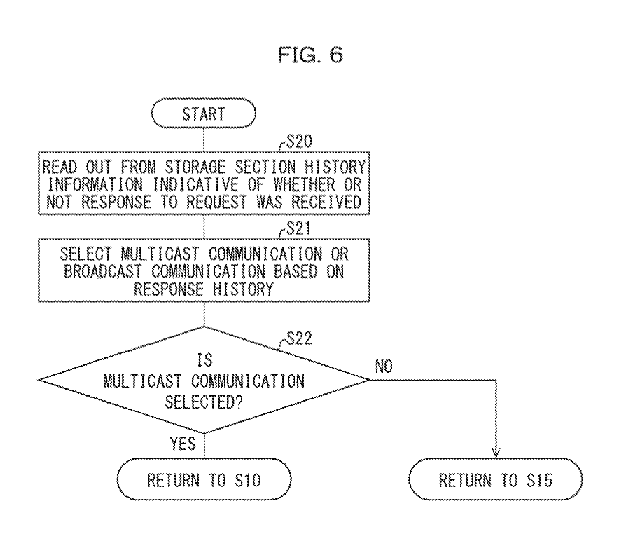

Next, Embodiment 4 of the present invention will be discussed below with reference to FIGS. 5 and 6. A wireless LAN system 1 in accordance with Embodiment 4 is identical in configuration to the wireless LAN system 1 illustrated in FIGS. 1 through 4, except for a mobile terminal 4. Specifically, a control section 30 and a storage section 31 of the mobile terminal 4 in accordance with Embodiment 4 differ, in configuration, from those of the wireless LAN system 1 illustrated in FIGS. 1 through 4.

FIG. 5 is a block diagram schematically illustrating a configuration of the mobile terminal 4 in accordance with Embodiment 4. The control section 30 illustrated in FIG. 5 is identical in configuration to the control section 30 illustrated in FIG. 3, except that the control section 30 illustrated in FIG. 5 (i) further includes a system-selecting section 44 and (ii) includes a section 41a for requesting multicast and a section 42a for requesting broadcast instead of the section 41 for requesting multicast and the section 42 for requesting broadcast, respectively. A storage section 31 illustrated in FIG. 5 is identical to the storage section 31 illustrated in FIG. 3, except that the storage section 31 illustrated in FIG. 5 further stores therein history information 50.

The history information 50 indicates a history as to whether a wireless router 3 can carry out a multicast and/or a broadcast.

The system-selecting section 44 is provided between (ii) an instruction-receiving section 40 and (ii) respective of the section 41a for requesting multicast and the section 42a for requesting broadcast. Upon receipt of an instruction from the instruction-receiving section 40, the system-selecting section 44 refers to the history information 50 stored in the storage section 31, and then selects whether a request should be made based on a multicast system or a broadcast system. Based on a selected result, the system-selecting section 44 gives an instruction to the section 41a for requesting multicast or to the section 42a for requesting broadcast.

The section 41a for requesting multicast is identical in configuration to the section 41 for requesting multicast illustrated in FIG. 3, except that the section 41a for requesting multicast (i) transmits a request for multicast to the wireless router 3 based on an instruction from the system-selecting section 44 and (ii) adds, to the history information 50 stored in the storage section 31, information indicative of whether a response was received as information indicative of whether the wireless router 3 was successful in carrying out a multicast.

The section 42a for requesting broadcast is identical in configuration to the section 42 for requesting broadcast illustrated in FIG. 3, except that the section 42a (i) transmits a request for broadcast to the wireless router 3 in accordance with respective instructions from the system-selecting section 44 and the section 41a for requesting multicast and (ii) adds, to the history information 50 stored in the storage section 31, information indicative of whether a response was received as information indicative of whether the wireless router 3 was successful in carrying out a broadcast.

FIG. 6 is a flowchart illustrating how the mobile terminal 4 collects status information. In a case where a user instructs, via an operating section 34, the mobile terminal 4 to collect pieces of status information of respective home information appliances 5, the system-selecting section 44 reads out, from the storage section 31, the history information 50 indicative of whether a response was received (S20), and selects, based on the history information 50 thus read out, whether the wireless router 3 carries out a multicast or a broadcast (S21) (see FIG. 6).

For example, in a case where the wireless router 3 was previously successful in carrying out a multicast, the system-selecting section 44 selects a multicast. In a case where the router 3 was previously successful in carrying out a broadcast, the system-selecting section 44 selects a broadcast. In a case where an event continues successively three times in which the router 3 is not previously successful in carrying out a multicast but is successful in carrying out a broadcast, the system-selecting section 44 selects the broadcast.

In a case where the system-selecting section 44 selects a multicast (YES in S22), the step S10 illustrated in FIG. 4 is proceeded with. This causes (i) a request for multicast to be transmitted to the wireless router 3, and then (ii) steps subsequent to the step S10 in FIG. 4 to be proceeded with. In contrast, in a case where the system-selecting section 44 did not select a multicast, i.e., in a case where the system-selecting section 44 selected a broadcast (NO in S22), the step S15 illustrated in FIG. 4 is proceeded with. This causes (i) a request for broadcast to be transmitted to the wireless router 3 and then (ii) steps subsequent to the step S15 in FIG. 4 to be proceeded with.

Embodiment 4 therefore allows a reduction in possibility of failing to receive, via the wireless router 3, a response to the request for status information. This consequently makes it possible to efficiently and more securely transmit a request for pieces of status information to the respective home information appliances 5, while restraining an increase in load of the wireless LAN system 1.

Furthermore, Embodiment 4 carries out the following process in addition to the process illustrated in FIG. 4. That is, in a case where the section 41a for requesting multicast receives, via the wireless router 3, a response to a request for multicast (YES in S11), the section 41a (i) determines that the wireless router 3 has been successful in carrying out a multicast, (ii) adds information indicative of such a determination to the history information 50 stored in the storage section 31, and then (iii) causes the step S13 (see FIG. 4) to be proceeded with. In a case where the section 41a for requesting multicast receives, via the wireless router 3, no response to a request for multicast within a given period of time from transmission of the request for multicast (YES in S12), the section 41a (i) determines that the wireless router 3 was not successful in carrying out a multicast, (ii) adds information indicative of such a determination to the history information 50 stored in the storage section 31, and (iii) causes the step S14 (see FIG. 4) to be proceeded with.

In a case where the section 42a for requesting broadcast receives, via the wireless router 3, a response to a request for broadcast (YES in S16), the section 42a determines that the wireless router 3 has been successful in carrying out a broadcast, adds information indicative of such a determination to the history information 50 stored in the storage section 31, and (iii) causes the step S13 (see FIG. 4) to be proceeded with. In a case where the section 42a for requesting broadcast receives, via the wireless router 3, no response to a request for broadcast within a given period of time from transmission of the request for broadcast (YES in S17), the section 42a (i) determines that the wireless router 3 was not successful in carrying out a broadcast, (ii) adds information indicative of such a determination to the history information stored in the storage section 31, and (iii) causes the step S10 (see FIG. 4) to be proceeded with.

### Embodiments 5 and 8

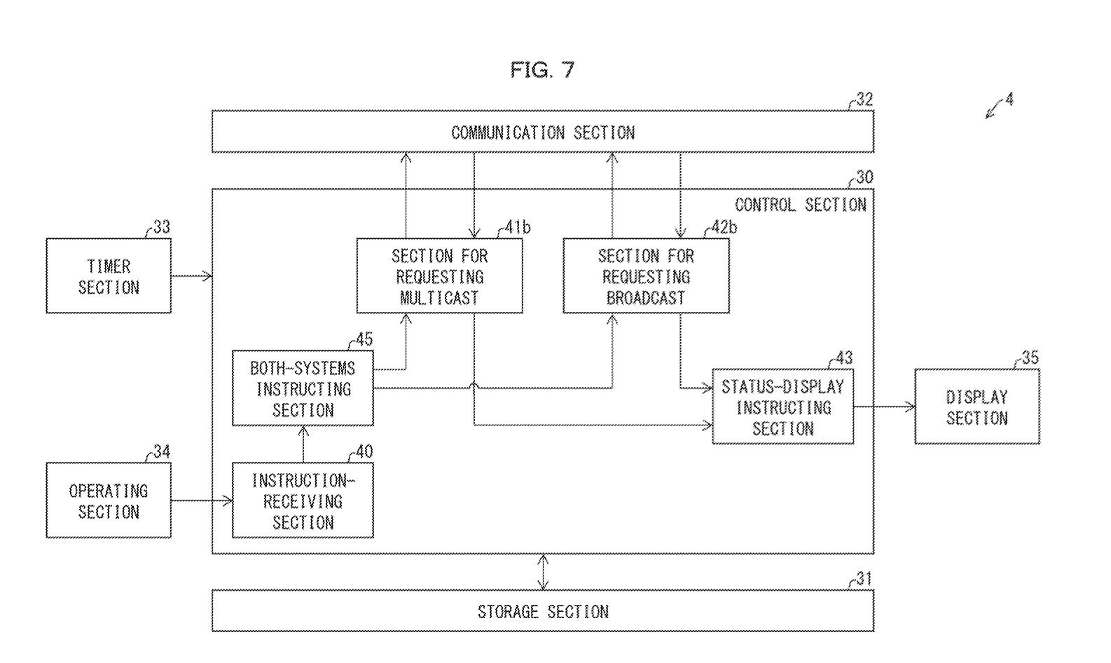

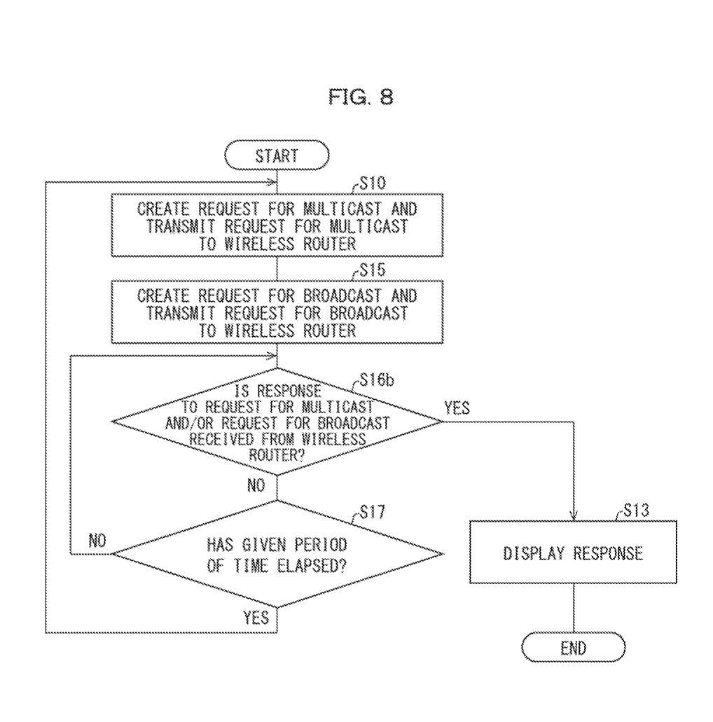

Next, each of Embodiments 5 and 8 of the present invention will be discussed below with reference to FIGS. 7 and 8. A wireless LAN system 1 in accordance with each of Embodiments 5 and 8 is identical in configuration to the wireless LAN system 1 illustrated in FIGS. 1 through 4, except for a mobile terminal 4. Specifically, a control section 30 of the mobile terminal 4 in accordance with each of Embodiments 5 and 8 differs, in configuration, from that of the wireless LAN system 1 illustrated in FIGS. 1 through 4.

FIG. 7 is a block diagram schematically illustrating a configuration of the mobile terminal 4 in accordance with each of Embodiment 5 and 8. The control section 30 illustrated in FIG. 7 is identical in configuration to the control section 30 illustrated in FIG. 3, except that the control section 30 illustrated in FIG. 7 (i) further includes a both-systems instructing section 45 and (ii) includes a section 41b for requesting multicast and a section 42b for requesting broadcast, instead of the section 41 for requesting multicast and the section 42 for requesting broadcast, respectively.

The both-systems instructing section 45 is provided between (i) an instruction-receiving section 40 and (ii) respective of the section 41b for requesting multicast and the section 42b for requesting broadcast. Upon receipt of an instruction from the instruction-receiving section 40, the both-systems instructing section 45 instructs the section 41b for requesting multicast and the section 42b for requesting broadcast to make a request for multicast and a request for broadcast, respectively.

The section 41b for requesting multicast is identical in configuration to the section 41 for requesting multicast illustrated in FIG. 3, except that the section 41b gives no instruction to the section 42b. The section 42b for requesting broadcast is identical in configuration to the section 42 for requesting broadcast illustrated in FIG. 3, except that the section 42b for requesting broadcast (i) transmits, to a wireless router 3, a request for broadcast in accordance with an instruction from the both-systems instructing section 45 and (ii) gives no instruction to the section 41b for requesting multicast.

FIG. 8 is a flowchart illustrating how the mobile terminal 4 collects status information. The process illustrated in FIG. 8 is identical to the process illustrated in FIG. 4, except that the process illustrated in FIG. 8 (i) does not include the steps S11 through S14 (see FIG. 4) and (ii) includes the step S16b instead of the step S16 (see FIG. 4).

In the step S16, it is determined whether the section 42 for requesting broadcast has received, via the wireless router 3, a response to the request for broadcast. In contrast, in the step S16b, it is determined whether a response to at least one of (i) the request for multicast made by the section 41b for requesting multicast and (ii) the request for broadcast made by the section 42b for requesting broadcast was received.

According to each of Embodiments 5 and 8, in a case of collecting pieces of status information from respective home information appliances 5, the mobile terminal 4 is configured to transmit to the wireless router 3, as a request (message) for the pieces of status information, (i) a request for multicast in which the home information appliances 5 (i.e., a group of one or more terminals) are designated as respective destinations and (ii) a request for broadcast in which all information terminals, which are connected so as to communicate with the wireless router 3, are designated as respective destinations.

With the configuration, the likelihood is increased that such a request (message) for the pieces of status information is more securely transmitted to the respective home information appliances 5, although an increase is caused in load on the wireless LAN system 1 as compared with a case where only one of the request for multicast and the request for broadcast is transmitted to the wireless router 3.

Note also that, with the above configuration, the likelihood is increased that such a request (message) for the pieces of status information is more securely transmitted to the respective home information appliances 5, although an increase is caused in load on the wireless LAN system 1 as compared with a case where the request for multicast is transmitted successively twice to the wireless router 3. With the above configuration, it is further possible to reduce load on the wireless LAN system 1, as compared with a case where the request for broadcast is transmitted successively twice to the wireless router 3.

It is therefore possible to securely transmit the request (message) for pieces of status information to the respective home information appliances 5, while restraining an increase in load on the wireless LAN system 1.

Note that the request for multicast and the request for broadcast can be simultaneously or successively transmitted to the wireless router 3. In a case where the requests are to be successively transmitted to the wireless router 3, (i) any of the request for multicast and the request for broadcast can be first transmitted and (ii) one of the request for multicast and the request for broadcast can be first transmitted and then the other can be transmitted after a predetermined amount of time (e.g., after 10 seconds).

### Embodiment 61

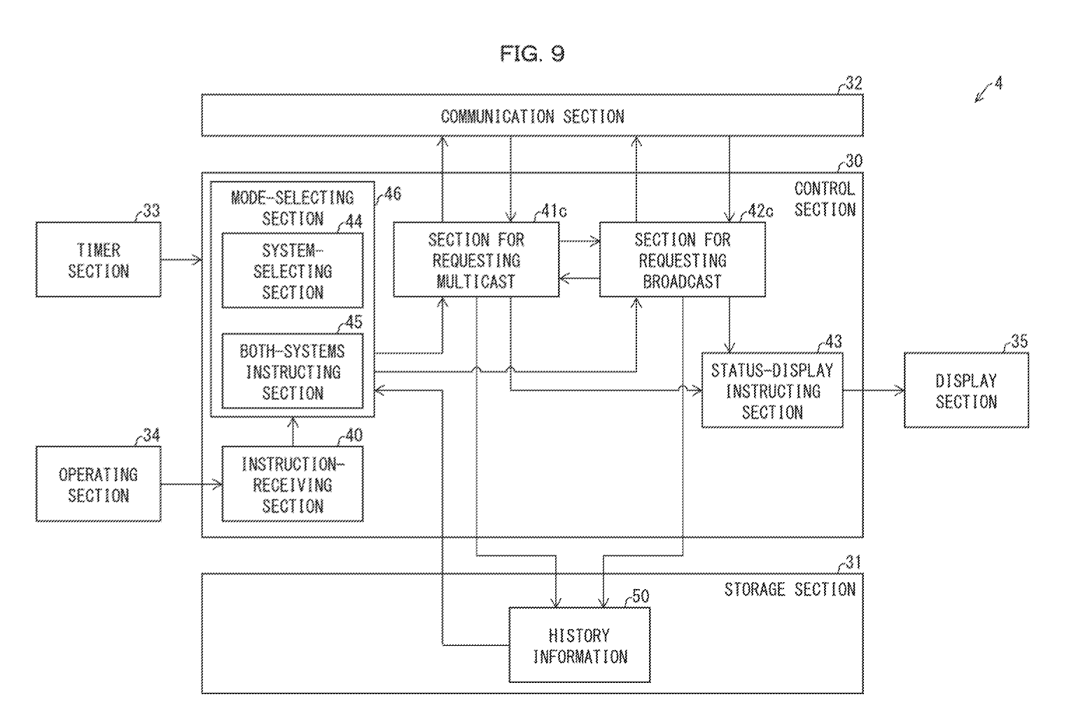

Next, Embodiment 6 of the present invention will be discussed below with reference to FIG. 9. A wireless LAN system 1 in accordance with Embodiment 6 is identical in configuration to the wireless LAN system 1 illustrated in FIGS. 1 and 2, except for a configuration of a mobile terminal 4.

FIG. 9 is a block diagram schematically illustrating the configuration of the mobile terminal 4 in accordance with Embodiment 6. The mobile terminal 4 illustrated in FIG. 9 is identical in configuration to the mobile terminal 4 illustrated in FIG. 5, except that a control section 30 of the mobile terminal 4 illustrated in FIG. 9 includes a mode-selecting section 46, a section 41c for requesting multicast, and a section 42c for requesting broadcast, instead of the system-selecting section 44, the section 41a for requesting multicast, and the section 42a for requesting broadcast, respectively.

The mode-selecting section 46 includes (i) the both-systems instructing section 45 illustrated in FIG. 7 and (ii) the system-selecting section 44 illustrated in FIG. 5. The mode-selecting section 46 selects (i) a first mode for causing the both-system instructing section 45 to operate and (ii) a second mode for causing the system-selecting section 44 to operate.

The section 41c for requesting multicast has respective functions of the section 41b for requesting multicast illustrated in FIG. 7 and the section 41a for requesting multicast illustrated in FIG. 5. Upon receipt of an instruction from the both-system instructing section 45, the section 41c for requesting multicast functions as the section 41b for requesting multicast, whereas upon receipt of an instruction from the system-selecting section 44, the section 41c for requesting multicast functions as the section 41a for requesting multicast. Note, however, that according to Embodiment 6, even in a case where the section 41c for requesting multicast functions as the section 41b for requesting multicast, it adds, to history information 50 stored in a storage section 31, information indicative of whether a response to the request for multicast was received as information indicative of whether the wireless router 3 was successful in carrying out a multicast, as with the section 41a for requesting multicast.

The section 42c for requesting broadcast has respective functions of the section 42b for requesting broadcast illustrated in FIG. 7 and the section 42a for requesting broadcast illustrated in FIG. 5. Upon receipt of an instruction from the both-systems instructing section 45, the section 42c for requesting broadcast functions as the section 42b for requesting broadcast, whereas upon receipt of an instruction from the system-selecting section 44, the section 42c for requesting broadcast functions as the section 42a for requesting broadcast. Note, however, that according to Embodiment 6, even in a case where the section 42c for requesting broadcast functions as the section 42b for requesting broadcast, it adds, to the history information 50 stored in the storage section 31, information indicative of whether a response to the request for broadcast was received as information indicative of whether the wireless router 3 was successful in carrying out a broadcast, as with the section 42a for requesting broadcast.

Note here that, as is clear from comparison of (i) Embodiments 5 and 8 and (ii) Embodiments 1 through 4 and 7, according to the wireless LAN system 1 of each of Embodiments 1 through 4 and 7, a transmission of either the request for multicast or the request for broadcast can sometimes be only necessary. It is therefore likely that the load on the wireless LAN system 1 is reduced. In contrast, according to the wireless LAN system 1 in accordance with each of Embodiments 5 and 8, it is likely for the wireless router 3 to promptly receive a response to a request for broadcast. This is because the wireless LAN system 1 transmits the request for broadcast to the wireless router 3 without waiting for a response to a request for multicast.

According to Embodiment 6, in a case where the mode-selecting section 46 selects the first mode, the mobile phone 4 in accordance with Embodiment 6 functions as the mobile terminal 4 in accordance with Embodiment 5 (see FIGS. 7 and 8), whereas in a case where the mode-selecting section 46 selects the second mode, the mobile terminal 4 in accordance with Embodiment 6 functions as the mobile terminal 4 in accordance with Embodiment 4 (see FIGS. 5 and 6). As such, it is sufficient to select the first mode, in a case where a request for pieces of status information needs to be promptly and securely transmitted to the respective home information appliances 5. Whereas it is sufficient to select the second mode, in a case where (i) an increase in load on the wireless LAN system 1 needs to be restrained and (ii) the request needs to be securely transmitted to each of the home information appliances 5. It is therefore possible to securely transmit a request for pieces of status information to the respective home information appliances 5 in accordance with the situation.

Note that the mode-selecting section 46 preferably selects (i) the first mode a plurality of times (e.g., five times) so that the both-systems instructing section 45 to operate and then (ii) the second mode. In the first mode, information indicative of whether the wireless router 3 can carry out a multicast and a broadcast is promptly added to the history information 50 stored in the storage section 31. After that, in the second mode, the system-selecting section 44 refers to the history information 50 which has been read out from the storage section 31, and selects the multicast or the broadcast (S21 in FIG. 6).

This allows a reduction in possibility of failing to receive a response to the request for status information. It is therefore possible to efficiently and more securely transmit the request for pieces of status information to the respective home information appliances 5, while restraining an increase in load on the wireless LAN system 1. Note that the second mode can be switched to the first mode at a given cycle (e.g., one day) or when a network topology of the wireless LAN system 1 is changed.

(Supplemental Notes)

Note that according to Embodiments 1 through 8, a request for multicast and a request for broadcast are made by the mobile terminal 4. Embodiments 1 through 8, however, are not limited to any mobile terminal. Any terminal, such as an operating panel for central control, can make such a request for multicast and a request for broadcast.

[Software Implementation Example]

A control block of the mobile terminal 4 (in particular, the control section 30) can be realized by a logic circuit (hardware) provided in an integrated circuit (IC chip) or the like or can be alternatively realized by software as executed by a central processing unit (CPU).

In the latter case, the mobile terminal 4 includes: a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

[Main Points]

A terminal in accordance with Embodiment 1 of the present invention is a terminal (mobile terminal 4) which communicates with one or more terminals (home information appliances 5) via a communication network (wireless router 3), the terminal including: a control section (30) configured to control a communication between the terminal and the one or more terminals, in a case where the control section transmits a message (request) to a group of the one or more terminals, the control section controlling the communication so that a message for multicast, in which the group of the one or more terminals are designated as respective destinations, is transmitted to the communication network, in a case where the control section receives no response to the message for multicast from any of the group of the one or more terminals within a given period of time from transmission of the message for multicast, the control section controlling the communication so that a message for broadcast, in which all of the one or more terminals are designated as the respective destinations, is transmitted to the communication network.

With the above configuration, in a case of transmitting a message to the group of the one or more terminals, the control section transmits, to the communication network, a message for multicast in which the group of one or more terminals are designated as respective destinations. This allows a reduction in load on the communication network as compared with a case where the control section transmits, to the communication network, a message for broadcast in which all of the one or more terminals are designated as respective destinations.

In a case where no response to the message for multicast was received within a given period of time from the transmission of the message for multicast, the control section transmits a message for broadcast to the communication network. This allows the message to be more securely transmitted to each of the group of the one or more terminals, although an increase is caused in load on the communication network as compared with a case where the control section transmits the message for multicast to the communication network.

It is therefore possible to securely transmit the message to each of the group of the one or more terminals, while restraining an increase in load on the communication network.

Note here that even the communication network, which is compliant with a multicast and a broadcast, can sometimes not make the multicast and the broadcast depending on a traffic condition of communications made on the communication network. It is, however, highly likely that the multicast and/or the broadcast are carried out after a while.

The terminal in accordance with Embodiment 2 of the present invention is therefore configured such that, in Embodiment 1 of the present invention, in a case where no response to the message for multicast is received from any one of the one or more terminals within a given period of time from the transmission of the message for multicast, the control section retransmits the message for multicast to the communication network, and in a case where the control section has transmitted, to the communication network, the message for multicast a given number of times but receives no response, the control section transmits the message for broadcast to the communication network.

The terminal in accordance with Embodiment 3 of the present invention can be configured such that, in Embodiment 1 or 2 of the present invention, in a case where no response to the message for broadcast is received within a given period of time from the transmission of the message for broadcast, the control section retransmits the message for multicast to the communication network.

The above configurations make it possible to more securely transmit the message to each of specific destinations, while restraining an increase in load on the communication network.

A terminal in accordance with Embodiment 5 of the present invention is a terminal which communicates with one or more terminals via a communication network, the terminal including: a control section configured to control a communication between the terminal and the one or more terminals, in a case where the control section transmits a message to a group of the one or more terminals, the control section controlling the communication so that (i) a message for multicast, in which the group of the one or more terminals are designated as respective destinations, and (ii) a message for broadcast, in which all of the one or more terminals are designated as respective destinations, are transmitted to the communication network.

With the above configuration, in a case of transmitting a message to the group of one or more terminals, the control section transmits, to the communication network, the message for multicast and the message for broadcast. This allows the message to be more securely transmitted to each of the group of the one or more terminals although an increase is caused in load on the communication network as compared with a case where the control section transmits, to the communication network, only one of the message for multicast and the message for broadcast.

The above configuration allows the message to be more securely transmitted to each of the group of the one or more terminals although an increase is caused in load on the communication network as compared with a case where the control section transmits, to the communication network, the message for multicast successively twice. The above configuration also allows a reduction in load on the communication network as compared with a case where the control section transmits, to the communication network, the message for broadcast successively twice.

It is therefore possible to securely transmit the message to each of the group of the one or more terminals, while restraining an increase in load on the communication network.

Note that the message for multicast and the message for broadcast can be simultaneously or successively transmitted to the communication network. In a case where the messages are to be successively transmitted to the communication network, (i) any of the message for multicast and the message for broadcast can be first transmitted and (ii) one of the message for multicast and the message for broadcast can be first transmitted and then the other can be transmitted after a predetermined amount of time.

The terminal in accordance with each of Embodiments 4 and 6 of the present invention can be configured to further include, in any one of Embodiments 1 through 3 and 5 of the present invention, a storage section (31) configured to store therein history information (50) indicative of whether the control section has been successful in receiving a response to the message for multicast and/or the message for broadcast, in a case where the control section transmits the message to the group of the one or more terminals, the control section controlling the communication so that (i) the message for multicast or (ii) the message for broadcast is transmitted to the communication network based on the history information. This makes it possible to securely and efficiently transmit the message to respective specific destinations, while restraining an increase in load on the communication network.

The terminal in accordance with each embodiment of the present invention may be realized by a computer. In such a case, the present invention also encompasses a control program for the terminal which program causes a computer to operate sections (software elements) of the terminal so as to realize the terminal by the computer, and a computer-readable storage medium in which the control program is stored.

A method of controlling a terminal in accordance with Embodiment 7 of the present invention is method of controlling a terminal which communicates with one or more terminals via a communication network, the method including the steps of: in a case where a message is transmitted to a group of the one or more terminals, controlling a communication so that a message for multicast, in which the group of the one or more terminals are designated as respective destinations, is transmitted to the communication network, in a case where no response to the message for multicast is received from any of the group of the one or more terminals within a given period of time from transmission of the message for multicast, controlling the communication so that a message for broadcast, in which all of the one or more terminals are designated as the respective destinations, is transmitted to the communication network. This method brings about an effect similar to that brought about by Embodiment 1.

A method of controlling a terminal in accordance with Embodiment 8 of the present invention is a method of controlling a terminal which communicates with one or more terminals via a communication network, the method including the step of: in a case of transmitting a message to a group of the one or more terminals, controlling a communication so that (i) a message for multicast, in which the group of the one or more terminals are designated as respective destinations, and (ii) a message for broadcast, in which all of the one or more terminals are designated as respective destinations, are transmitted to the communication network. This method brings about an effect similar to that brought about by Embodiment 5.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### INDUSTRIAL APPLICABILITY

According to an aspect of the present invention, in a case where a terminal transmits a message to one or more terminals, it first transmits a message for multicast to a communication network. In a case where no response to the message for multicast is received within a given period of time from the transmission of the message for multicast, it transmits a message for broadcast to the communication network. This makes it possible to securely transmit the message to each of the group of the one or more terminals, while restraining an increase in load on the communication network. The present invention is therefore applicable not only to a mobile terminal but also to any terminal other than the mobile terminal.

### REFERENCE SIGNS LIST

1: Wireless LAN system (communication network)
2: User's home
3: Wireless router (communication network)
4: Mobile terminal (terminal)
5: Home information appliance (one or more terminals)
6: Home appliance main body
7: Home appliance adapter
10, 20, 30: Control section
11, 21, 31: Storage section
12, 32: Communication section
13, 27: Connecting section
22: Home appliance function section
23: Status-detecting section
24: Voice output section
25, 35: Display section
26, 34: Operating section
33: Timer section
40: Instruction-receiving section
41, 41a through 41c; Section for requesting multicast
42, 42a through 42c: Section for requesting broadcast
43: Status-display instructing section
44: System-selecting section
45: Both-systems instructing section
46: Mode-selecting section
50: History information

1. A terminal which communicates with one or more terminals via a communication network, the terminal comprising:
a control section configured to control a communication between the terminal and the one or more terminals,
in a case where the control section transmits a message to a group of the one or more terminals, the control section controlling the communication so that a message for multicast, in which the group of the one or more terminals are designated as respective destinations, is transmitted to the communication network,
in a case where the control section receives no response to the message for multicast from any of the group of the one or more terminals within a given period of time from transmission of the message for multicast, the control section controlling the communication so that a message for broadcast, in which all of the one or more terminals are designated as the respective destinations, is transmitted to the communication network.

2. A terminal which communicates with one or more terminals via a communication network, the terminal comprising:
a control section configured to control a communication between the terminal and the one or more terminals,
in a case where the control section transmits a message to a group of the one or more terminals, the control section controlling the communication so that (i) a message for multicast, in which the group of the one or more terminals are designated as respective destinations, and (ii) a message for broadcast, in which all of the one or more terminals are designated as respective destinations, are transmitted to the communication network.

3. The terminal as set forth in claim 1, further comprising:
a storage section configured to store therein history information indicative of whether the control section has been successful in receiving a response to the message for multicast and/or the message for broadcast,
in a case where the control section transmits the message to the group of the one or more terminals, the control section controlling the communication so that (i) the message for multicast or (ii) the message for broadcast is transmitted to the communication network based on the history information.

4. A method of controlling a terminal which communicates with one or more terminals via a communication network, the method comprising the steps of:
in a case where a message is transmitted to a group of the one or more terminals, controlling a communication so that a message for multicast, in which the group of the one or more terminals are designated as respective destinations, is transmitted to the communication network,
in a case where no response to the message for multicast is received from any of the group of the one or more terminals within a given period of time from transmission of the message for multicast, controlling the communication so that a message for broadcast, in which all of the one or more terminals are designated as the respective destinations, is transmitted to the communication network.

5. A method of controlling a terminal which communicates with one or more terminals via a communication network, the method comprising the step of:
in a case of transmitting a message to a group of the one or more terminals, controlling a communication so that (i) a message for multicast, in which the group of the one or more terminals are designated as respective destinations, and (ii) a message for broadcast, in which all of the one or more terminals are designated as respective destinations, are transmitted to the communication network.

6. The terminal as set forth in claim 1, wherein
in a case where no response to the message for multicast is received from any one of the one or more terminals within a given period of time from the transmission of the message for multicast, the control section retransmits the message for multicast to the communication network, and
in a case where the control section has transmitted, to the communication network, the message for multicast a given number of times but receives no response, the control section transmits the message for broadcast to the communication network.

7. The terminal as set forth in claim 1, wherein
in a case where no response to the message for broadcast is received within a given period of time from the transmission of the message for broadcast, the control section retransmits the message for multicast to the communication network.

8. The terminal as set forth in claim 1, wherein
in a case where the control section transmits the message to the group of the one or more terminals, the control section selects a first mode and a second mode,
in the first mode, (i) the control section transmits the message for multicast to the communication network, and (ii) in a case where the control section receives no response to the message for multicast from any of the group of the one or more terminals within a given period of time from transmission of the message for multicast, the control section transmits the message for broadcast to the communication network, and
in the second mode, the control section transmits the message for multicast and the message for broadcast to the communication network.
